(19) United States
(12) Patent Application Publication
(10) Pub. No.: US 2013/0151422 A1
(43) Pub. Date: Jun. 13, 2013

(54) RANK AND DISPLAY COMPARABLES WITH USER-ALTERABLE DATA POINTS

(71) Applicants: Megan C. Berry, Rockville, MD (US); James Fluckiger, Potomac Falls, VA (US); James Gottlieb, Reston, VA (US); Eric Rosenblatt, Derwood, MD (US); Angela Tseng, Germantown, MD (US)

(72) Inventors: Megan C. Berry, Rockville, MD (US); James Fluckiger, Potomac Falls, VA (US); James Gottlieb, Reston, VA (US); Eric Rosenblatt, Derwood, MD (US); Angela Tseng, Germantown, MD (US)

(73) Assignee: Fannie Mae, Washington, DC (US)

(21) Appl. No.: 13/313,100

(22) Filed: Dec. 7, 2011

(51) Int. Cl. G06Q 50/16

(52) U.S. Cl. 705/306

(57) ABSTRACT

Automatically rendering a new valuation for a subject based on real-time property characteristic alterations or manipulations using a comparable selection model. A user alters one or more property characteristics for the subject and the comparable selection model determines a ranked listing of comparable properties for the subject in a given geographical area based on those alterations. The comparables are then displayed in a ranked order that reflects the alterations based on prior data point changes.

### BACKGROUND OF THE INVENTION

1. Field of the Invention

This application relates generally to manipulating data points for a subject property such that a model pulls a new list of comparables properties for the subject property and provides a new valuation based on the new list of comparables properties. Particularly, the subject and comparables properties, which are selected based on their similarity to the subject, are available in a format that permits data point selection and alteration. More particularly, once the data points are selected and altered and the model is run, the model will then display the comparables in a ranked order that reflects the alterations based on prior data point changes.

2. Description of the Related Art

What is needed is a method that provides a subject with user-alterable data points for objective evaluation in real time based on the altered data points and using comparable sales to extract the change in value for the subject in a given market.

Determining whether an addition or a change to a property is monetarily appropriate, whether accurate comparables sales are selected for said addition or change, or whether the relative value of a home or property is congruent to other properties in a geographic region is very difficult without extensive knowledge of a particular property, the surrounding areas, the relative history of that property, and the relative property characteristics of properties in the same market. Appraisers themselves and the appraisals they render are currently the main source for property values; however, these sources are inadequate for instant home improvement valuations.

In addition to the difficulty and required time for appraisers to subjectively predict the change in market value for a subject, performing quality assurance on subject alteration valuations requires another appraiser (thus, further time and more subjectivity) to perform a second evaluation on a property to prove that the first prediction was an accurate valuation. Further, instant home improvement valuations possess a public benefit due to the required extensive knowledge as detailed above, the limited human ability to analyze and compute such information, and the length of time required by human valuations. And since there is no current method for instant home improvement valuations, the below described invention offers and details a faster way to judge improvements without the need for additional human evaluations and appraisals.

### SUMMARY OF THE INVENTION

The present invention relates to a method for valuation of a subject based on real-time property characteristic alterations using a comparable selection model, further comprising receiving an input that alters one or more property characteristics for the subject, determining a ranked listing of comparable properties for the subject in a given geographical area by the comparable selection model based on the input, and performing a valuation on the subject based on the ranked listing to render a value for the subject.

Further, the method may perform a valuation on the subject using the comparable selection model to render an original value prior to receiving the input, calculate a difference between the value and the original value, and rank the value based on the difference between the value and the original value. Further, when multiple inputs are received each new valuation is ranked based on its respective difference from the original valuation of the subject. Ranking the value may also be based on cost estimates associated with the input and the difference between the value and the original value.

Furthermore, the property characteristics may include but are not limited to gross living area, lot size, property age, number of bathrooms, number of bedrooms, geographical feature of interest, maintenance conditions, waste removal systems, climate control systems, and parking.

Also, the method may further display on a display device the value and the ranked listing of comparable properties, wherein the display device is selected from a set of display devices that includes a light-emitting diode display, a liquid crystal display, an organic light-emitting diode display, a plasma display, and a cathode-ray display. Alternatively, the display device may be connected to or a part of an electronic device, wherein electronic device is selected from a set of electronic devices that includes personal computers, laptop personal computers, mobile phones, smart-phones, super-phones, tablet personal computers, and personal digital organizers.

An alternative embodiment may include a computer program product stored on a non-transitory computer readable medium that when executed by a computer performs a method for subject valuation based on real-time property characteristic alterations using a comparable selection model or an apparatus that based on real-time property characteristic alterations using a comparable selection model performs a valuation where a circuit performs the valuation on the subject.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIGS. 1A-B are block diagrams illustrating examples of systems in which an alteration and ranking application operates;

FIGS. 2A-B are block diagrams illustrating examples of an alteration and ranking application;

FIG. 3 is a flow diagram illustrating an example of an alteration and ranking process;

FIG. 4 is a flow diagram illustrating an example of a process for customizing neighborhoods; and

FIG. 5 is a flow diagram illustrating an example of a comparable selection process.

### DETAILED DESCRIPTION OF THE INVENTION

In the following description, for purposes of explanation, numerous details are set forth, such as flowcharts and system configuration, to provide an understanding of one or more embodiments. However, it is and will be apparent to one skilled in the art that these specific details are not required to practice the described.

The described relates to an ability to dynamically change, add, and remove values for a subject to instantaneously render a subject valuation based those altered values and a given market. In other words, a subject is evaluated or appraised on the basis of a series of initial ‘what if’ scenarios. The series of ‘what if’ scenarios may be a preformed set of conditions that are sequentially applied to a subject or the series may be a user or simulation designated set of alterations. According to one aspect, the series of ‘what if’ scenarios may be embodied in an application that includes program code executable to perform subject valuation based on real-time property characteristic alterations using a comparable selection model.

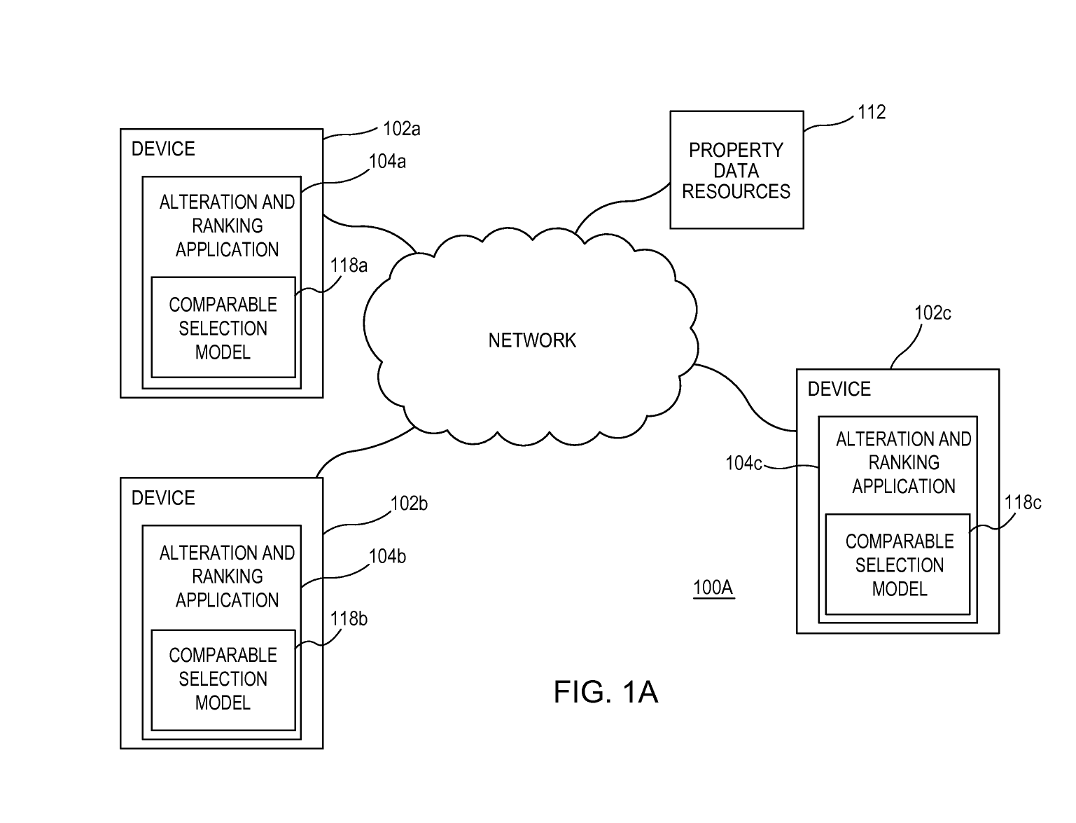

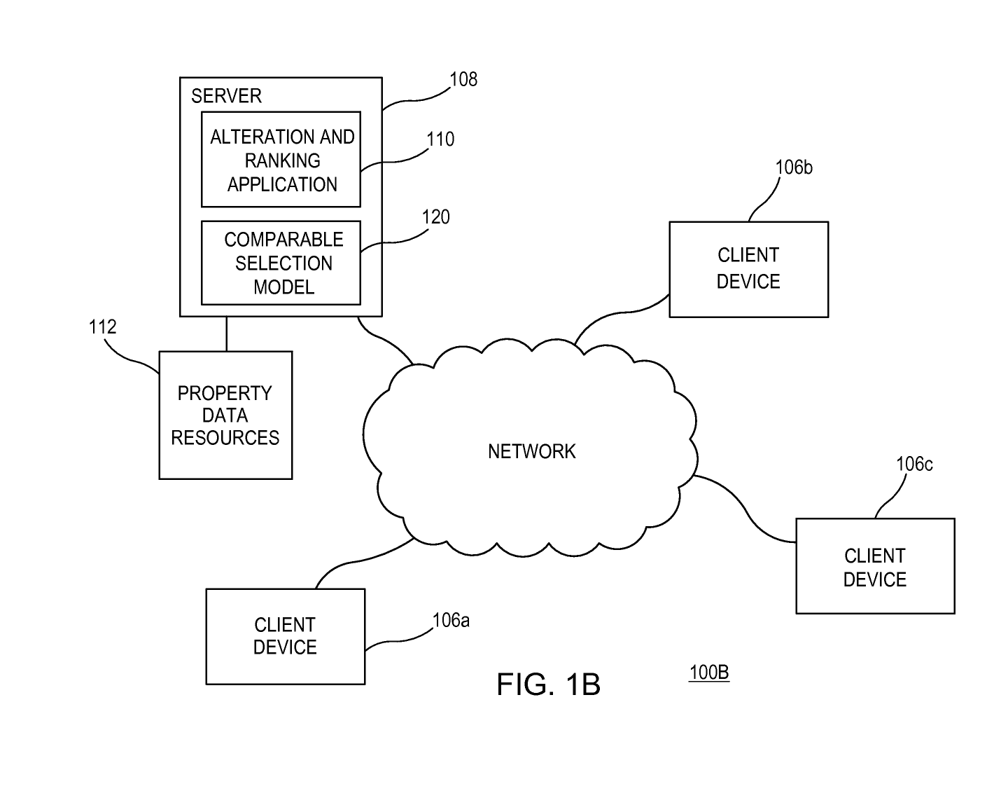

FIGS. 1A-B are block diagrams illustrating examples of systems in which an alteration and ranking application operates. Specifically, FIG. 1A is block diagram illustrating an example of a system 100A in which alteration and ranking applications 104a-c operate.

FIG. 1A further illustrates several user devices 102a-c each having an alteration and ranking application 104a-c installed thereon. The user devices 102a-c are preferably computer systems, which may be referred to as workstations, although they may be any conventional computing or electronic devices, such as personal computers, laptop personal computers, mobile phones, smart-phones, super-phones, tablet personal computers, personal digital organizers, and the like. The network over which the devices 102a-c (through their interfaces) may communicate may also implement any conventional technology, including but not limited to cellular, WiFi, WLAN, LAN, or combinations thereof. Alternatively, the user devices 102a-c may be configured as web terminals where alteration and ranking applications 104a-c are configured to run in the context of the functionality of a web browser application. This configuration may also implement a network architecture wherein any of the alteration and ranking applications 104a-c provide, share, and rely upon the other alteration and ranking application's functionality.

As an illustrated alternative in FIG. 1B, the devices 106a-c may respectively access a server 108, such as through conventional web browsing, with the server 108 providing the alteration and ranking application 110 and a comparable selection model 120 for access by the client devices 106a-c. In this embodiment, the alteration and ranking application 110 and the comparable selection model 120 are separate functions; however, the comparable selection model 120 may also be integrated into the alteration and ranking application 110, as depicted by the comparable selection models 118a-c in FIG. 1A. Further, as another alternative, the functionality of the alteration and ranking application 110 and the comparable selection model 120 may be divided between the computing devices and server, where either function may be located separately on either device and accessed through distributed computing. Finally, of course, a single computing device may be independently configured to include the alteration and ranking application 110 and the comparable selection model 120.

As illustrated in FIGS. 1A-B, however, property data resources 112 are typically accessed externally for use by the application, since the amount of property data is rather voluminous, and since the application is configured to allow access to any county or local area in a very large geographic area (e.g., for an entire country such as the United States). Additionally, the property data resources 112 are shown as a singular block in the figure, but it should be understood that the singular block represents a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The application accesses and retrieves the property data from these resources in support of dynamically changing values for the subject, instantaneous subject valuation, providing alterable data points, modeling of comparable properties as well as the rendering of map images of subject properties and corresponding comparable properties, and the display of supportive data (e.g., in grid form) in association with the map images.

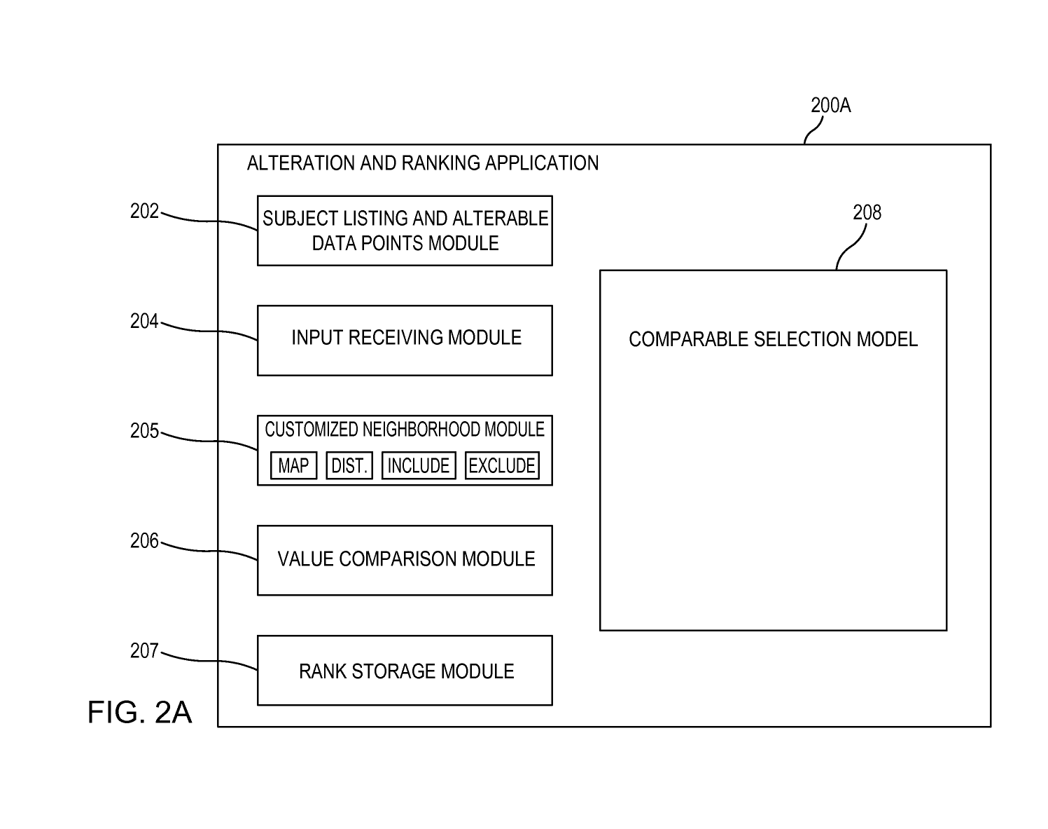

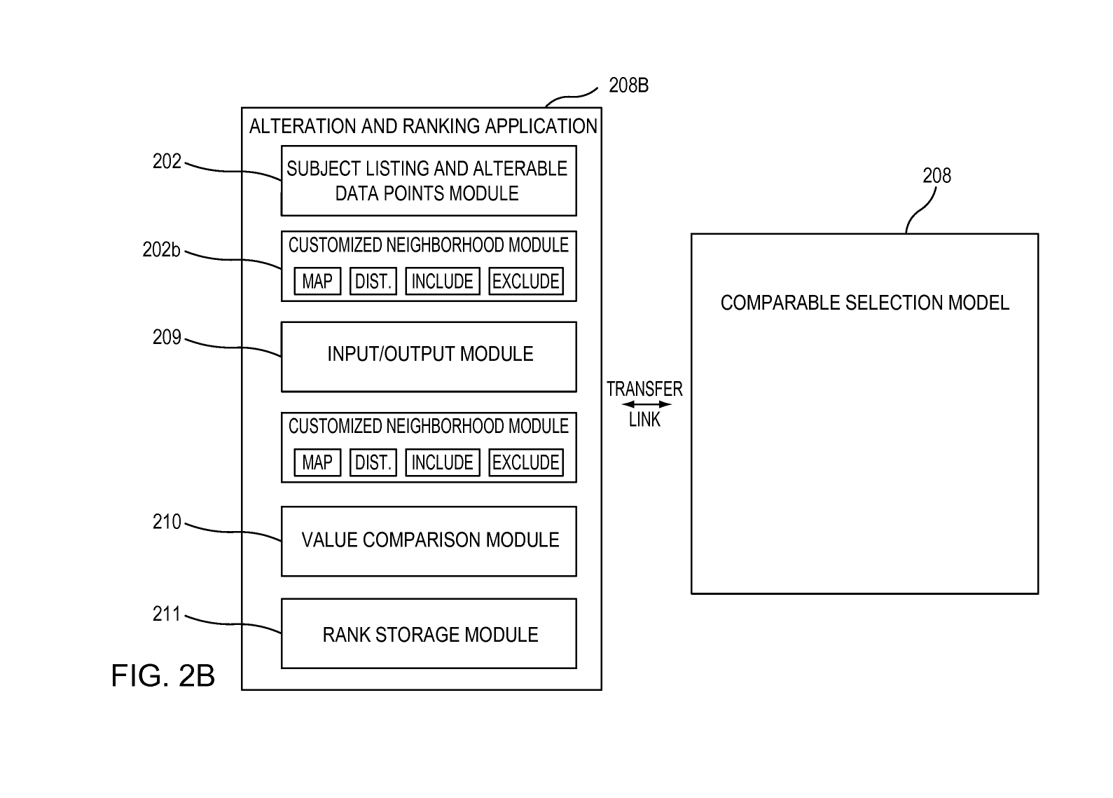

FIG. 2A-B are block diagrams illustrating examples of an alteration and ranking application. Specifically, FIG. 2A is a block diagram illustrating an example of an alteration and ranking application 200A where a comparable selection model 208 is integrated into the application. Further, the application preferably comprises program code that is stored on a non-transitory computer readable medium (e.g., compact disk, hard disk, etc.) and that is executable by a processor to perform operations in support of modeling and mapping comparable properties.

According to one aspect, the application includes program code executable to perform operations of receiving an input that alters one or more property characteristics for a subject, determining a ranked listing of comparable properties for the subject in a given geographical area by the comparable selection model based on the input, and performing a valuation on a subject based on the ranked listing to render a value for the subject. Further, determining a ranked listing in a given geographical area by the comparable selection model includes accessing property data corresponding to a geographic area, and performing a regression based upon the property data, with the regression modeling the relationship between price and explanatory variables. The application also includes program code for displaying (whether through a web browser, mobile application, or other relative interface) a map image corresponding to the geographic area, indicators on the map image indicative of the subject property and at least one of the plurality of comparable properties, as well as ranking the subject alterations, and a text listing of the plurality of comparable properties according to the ranking. Finally, the application is configured to receive other inputs indicating selection of comparable properties and to update the map images and indicators as described.

For example, the alteration and ranking application 200A is preferably provided as software on a device (102a-c), but may alternatively be provided as hardware or firmware, or any combination of software, hardware and/or firmware. The application 200A is configured to provide the subject valuation based on real-time property characteristic alterations using a comparable selection model's 208 functionality. Although one modular breakdown of the application 200A is offered, it should be understood that the same functionality may be provided using fewer, greater or differently named modules.

The example of the application 200A of FIG. 2A includes a subject listing and alterable data points module 202, an input receiving module 204, a customized neighborhood module 205, a value comparison module 206, a rank storage module 207, and the comparable selection model 208. And although it is not shown, the application 200A further includes a user interface module; however, the user interface module may be integrated with any of the shown modules.

The subject listing and alterable data points module 202 includes program code for mapping alterable data points or property characteristics on a subject, assigning default data point suggestions, and providing option boxes for further manual configurations. Further, the subject listing and alterable data points module 202 includes program code for gathering other user editable data, including pool filters, user options, appraisal comments, and the like. The input receiving module 204 includes program code for receiving input from a user interface or other source and forwarding the data to the appropriate destination, such as the comparable selection model 208, the value comparison module 206, or the rank storage module 207. The customized neighborhood module 205 is configured to apply customized geographic areas for comparable selection and is further described below (here, neighborhood is a term that means geographic area). The value comparison module 206 and rank storage module 207 manage each data point alteration and submission, such that a final valuation is rendered by the application for a subject or altered subject. Further, the value comparison module 206 calculates a difference between the final valuation of an altered subject and the original value of the subject (prior to altering). The rank storage module 207 ranks the final valuation of an altered subject based on calculated to provide a suggestion as to whether a subject's alteration is more desired among properties in a given market. The rank storage module 207 may also rank the final valuation of an altered subject based on the difference between the final valuation of an altered subject and other final values when additional values exists, such a that a specific alteration may be judged against other specific alterations in a given market. Also, the rank storage module 207 may rank the final valuation of an altered subject based on cost estimates associated with the alterations, which were derived from property data resources 112 and the above described calculated differences.

The comparable selection model 208 is configured for carrying out a regression upon the accessed property data and producing corresponding results, such as comparable property selection through the determination of regression coefficients and other data appropriate to a subject property.

The user interface module may manage the display and receipt of information from a user to provide the described functionality. It permits the management of the interfaces and input used to identify one or more subject changes, from which a determination of the corresponding comparables are selected and the displaying of the map images as well as the indicators of the subject property, the comparable properties, and ranked alterations. Further, the user interface module permits the property data for the properties to be displayed in a tabular or grid format, with various sorting functions according to the property characteristics, economic distance, geographic distance, time, etc.

The example of the application 200B of FIG. 2B includes a subject listing and alterable data points module 202 with a customized neighborhood module 202b, an input/output module 209, a valuation and ranking module 210, web interface and display module 211, and a user interface module (not shown). Further, the application 200B communicates with the comparable selection model 208, which is separate from the application 200B. It is understood that the comparable selection model 208 may be located externally or internally to a computer system that contains the application 200B (see FIG. 1B). That is, applications 200A-B may either integrate a comparable selection model or pull data from the comparable selection model.

In the FIG. 2B embodiment, the subject listing and alterable data points module 202 includes program code for the customized neighborhood module 202b, such that reverse control is given to the manipulation of the subject. That is, by first customizing a neighborhood the subject may be chosen as it fits the given customization. In other words, in FIG. 2A the application 200A provides or receives an alterable subject, supplies the relative comparable based on the subject, and then permits regulation of the comparables through neighborhood customization. In FIG. 2B, when the customized neighborhood module 202b is integrated with the subject listing and alterable data points module 202, the application 200B may first permit alteration of neighborhood boundaries, such that the pool of comparable properties is restricted even before a subject is given to the application 200B, then desired property characteristics may be selected for a desired subject and applied to the predefined neighborhood for evaluation of congruency. To further explain by example, a construction company may want to forecast what specific type of construction may render the highest value in predefined markets, such that the company may adjusts the property type selection and building costs to fit the geographic area where the construction, whether new or otherwise, is planed.

The input/output module 209 is configured to communicate directly with other application, modules, models, and devices through both physical and virtual interfaces. The valuation and ranking module 210 is a combined value comparison module 206 and rank storage module 207, as these may be programmed separately or together.

The web interface and display module 211 is configured to provide mapping and analytical tools that implement the application (a user interface would most likely be integrated with module 211; however, the user interface may also still be a separate module). Mapping features allow the subject property and comparable properties to be concurrently displayed (and geographic regions to be selected using the customized neighborhood module 205). For example, mapping features include the capability to display the boundaries of census units, school attendance zones, neighborhoods, as well as statistical information such as median home values, average home age, etc. The mapping features also accommodate the illustration of geographical features of interest along comparable properties, offering visual depiction of properties that border the feature.

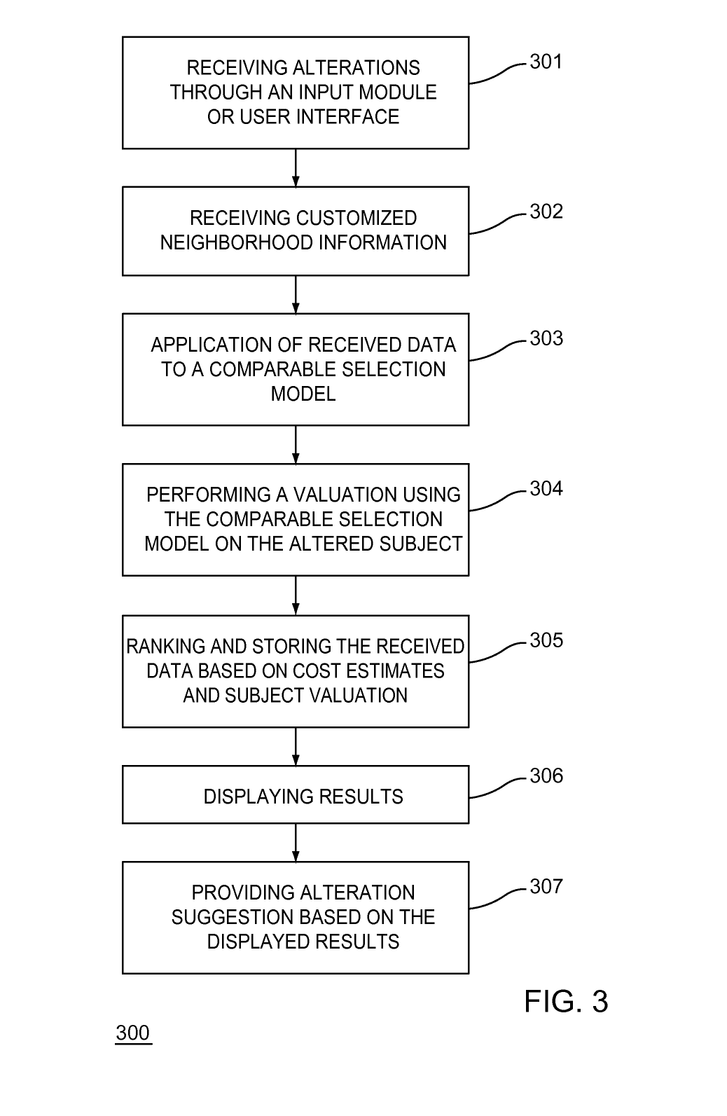

Additionally, a table or grid of data for the subject properties is concurrently displayable so that the list of comparables can be manipulated, with the indicators on the map image updating accordingly. The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales. Note, each module's functionality is further described in connection with FIGS. 3-5 below.

Further, the computer system described above may be a device (102a-c and 106a-c) that includes a central processing unit (CPU), an interface, and alteration and ranking application 200A-B resident in a memory, where the application includes instructions that are executed by a CPU. The computer system may be a conventional desktop computer, a network computer, a laptop personal computer, a handheld portable computer (e.g., tablet, PDA, cell phone) or any of various execution environments that will be readily apparent to the artisan and need not be named herein. The interface may be any interface suited for input and output of communication data, whether that communication is visual, auditory, electrical, transitive, or the like.

The computer system runs a conventional operating system through the interaction of the CPU and the memory to carry out functionality by execution of computer instructions. The memory may be any memory suitable for storing data, such as any volatile or non-volatile memory, whether virtual or permanent. Operating systems may include but are not limited to Windows, Unix, Linux, and Macintosh. The computer system may further implement applications that facilitate calculations including but not limited to MATLAB. The artisan will readily recognize the various alternative programming languages and execution platforms that are and will become available, and the present invention is not limited to any specific execution environment.

Therefore, the application is preferably provided as software on the computer system described above, yet it may alternatively be hardware, firmware, or any combination of software, hardware and firmware. Still other embodiments include computer implemented processes described in connection with the application 200A-B as well as the corresponding flow diagrams.

FIG. 3 is a flow diagram illustrating an example of an alteration and ranking process. Specifically, FIG. 3 is a flow diagram illustrating an example of an alteration and ranking process 300 that describes one possible operation sequence for application 200A-B.

A set of at least one or more altered property characteristics for the subject are received 301 by the application's user interface. Alternatively, an input module may receive an altered subject by other means. That is, while a user interface provides direct access to a subject and its alterable data points, an input module may be configured to receive an email, uploaded file, or the like that reflects similar changes.

A set of customized geographic or neighborhood conditions are also received 302 by the application user interface. Alternatively, an input module may receive predefined geographic regions. Both receiving alterations 301 and customized neighborhood conditions 302 are interchangeable based on the type of application employed (see FIGS. 2A-B). In plain terms, receiving 301 by the application initiates the ‘what if’ sequences described above. That is, although inputting different data will render a different answer, the described application itemizes how to specifically account for what data is being changed and how that data affects a property in a given market. For instance, ‘what if’ a homeowner wanted to add a bathroom, to add a 160 square foot addition, or to finish a basement? The application receives 301 these questions in the form of data points that are altered in real-time. Further, because the process also includes receiving 302 customized neighborhoods, the application, which displays a map image of a geographic area containing the subject property, will show the value of adding a bathroom, adding a 160 square foot addition, and finishing a basement relative to different geographic areas. In addition, characteristics that may be included in the set of alterable property characteristics include but is not limited to gross living area, lot size, property age, number of bathrooms, number of bedrooms, geographical feature of interest, maintenance conditions, waste removal systems, climate control systems, and parking.

Once the altered property characteristics and customized neighborhood conditions are received, a determination 303 of a ranked listing of comparable properties for the subject in a given geographical area by the comparable selection model based on these inputs is made. That is, with a new set of inputs (i.e. a change to any portion of the subject data) a new set of comparable properties must be selected and listed so that the subject can be reappraised. Thus, the application using the comparable selection model performs 304 a valuation on the subject based on the new set of comparable properties. Further, the application may calculate the difference between the new valuation and the original valuation to show the ‘before and after’ and to show where the relative increases are dictated. Relative increase may be stored in a memory, such that further alterations may be made and therefore the process 300 loops. As the process loops, each relative increase may be ranked.

The application ranks 305 the reappraisals based on the difference between the reappraisals and a subject's original value to show which alteration increases or decreases a subject's value in a given market. Further, the application may rank the reappraisals based on cost estimates associated with the alteration. For example, in a given market, finishing a basement in a one bathroom home may cost $5,000 while raising the value of a subject by $10,000; transforming an extra closet into a half bathroom in the same home may cost $400 while raising the value of a subject by $4,000. The application may rank the half bathroom alteration higher than the finished basement because the relative increase to the home based on the cost invested is greater for the half bathroom. Thus, the application continuously reappraises and stores those reappraisals, such that the best ‘what if’ from a series of ‘what if’ may be readily identified. For instance, the application when given a sequence of scenarios (such as 1. what if we knock the house down and rebuild, 2. what if we add another flood, 3. what if we install an in-ground pool, and 4. ‘what if the appraiser entered the wrong data initially) will reappraises, stores those reappraisals, and rank the reappraisals based on a set of defined conditions.

While or after the process 300 ranks and stores appraisals, the application causes a display device to displays 306 a map, valuations, ranked listing of comparable properties, and other property data compiled and processed by the application.

For example, map image information may be acquired from mapping resources, including but not limited to Google maps and the like, and techniques may be used to depict the subject and comparable properties on the map image, such as through determination of the coordinates from address information. The map imagery may be variously updated to provide desired views, including zooming in and out to provide more narrow or broad perspectives of the depictions of the comparable and subject properties. Additionally, the map imagery is updated to reflect the current display of various geographical features. In one example, a body of water may be depicted as a geographical feature in the map image, along with parcels corresponding to properties. In another example, the application may implement determinations whether a property borders geographical features including highways or other major roads, parks, golf courses, mass transit, commercial properties/zones, cul-de-sacs, power plants, railroads, garbage dumps, etc.

Further, the property data may include information as to the location of the properties, and either this native data may be used, or it may be supplemented, to acquire that exact location of the subject property and potential comparable properties on the map image. This allows the map image to be populated with indicators that display 306 the location of the subject property and the comparable properties in visually distinguishable fashion on the map image. The number of comparable properties that are shown can be predetermined or may be configurable based upon preferences. The number of comparable properties that are shown may also update depending upon the level of granularity of the image.

In addition, property alteration suggestions made be provided 307 by the application based on property data resources (such as a catalogue for home improvement cost estimates). That is, the application may provide 307 suggestions based on the cost/benefit rankings, such as adding another floor to a home, altering the landscape of a property, etc. and homeowners, construction companies, and investors will find more security in their business decisions.

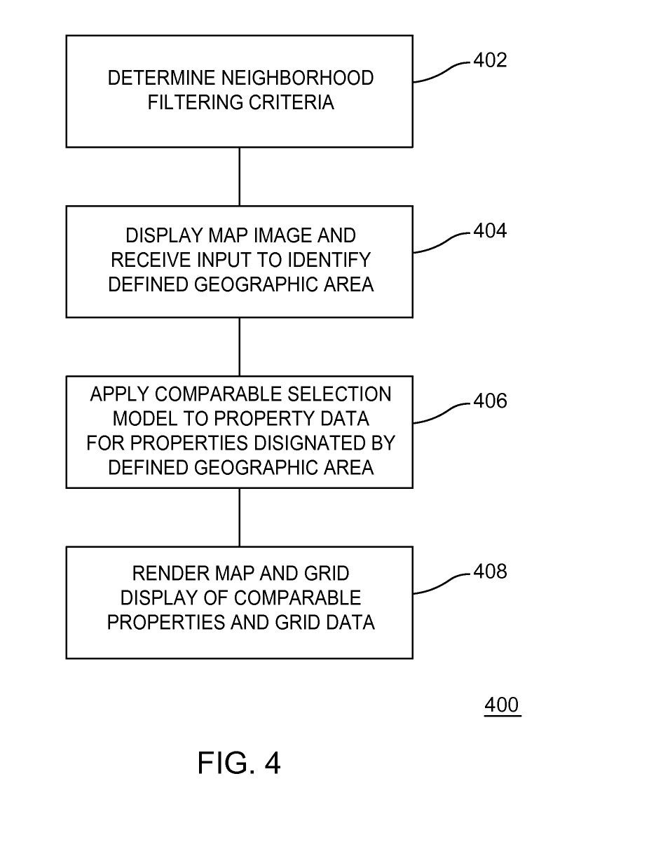

FIG. 4 is a flow diagram illustrating an example of a process for customizing neighborhoods. Specifically, FIG. 4 is a flow diagram illustrating an example of a process 400 for customizing neighborhoods with the customized neighborhood module 205 or customized neighborhood module 202B.

The process 400 entails determining 402 the neighborhood filtering criteria. Next, a map image is displayed 404 and necessary input is obtained to define the geographic area (using for example the web interface and display module 211 in the case of FIG. 2B). There are different modes that may be employed when selecting a geographic area. In a Tract mode, when selection or other identification of the subject property performed, the contiguous tracts (predefined groups based on census information) define the geographic area. In a Distance mode, the subject property and desired distance define the geographic area. In a map mode, the map image is manipulated (if desired) and then upon indication the geographic area is set as the currently-displayed geographic area. A Carve In and Carve Out mode entails interfacing with the user to receive indications to define the shape that in turn defines the geographic area. This may be a manual stringing of segments to define a shape such as a polygon that forms a perimeter of the defined geographic area. Alternatively, a shape tool allows the user to overlay and then resize and manipulate the shape to configure it as desired, so as to match it to whatever the user deems to be the appropriate neighborhood. Automated assistance may also be provided, wherein the application identifies and then suggests a possible boundary of the shape, such as a major road, body of water or the like.

Once the defined geographic area is established, the comparable selection model is applied 406 to corresponding property data for properties designated by the defined geographic area (whether by inclusion, as with Map, Tract, Distance, or Carve In modes, or exclusion as with Carve Out mode).

Application of the model identifies a set of model-chosen comparable properties. The rendering 408 of the map image is then updated to include the subject property and the comparable properties so as to illustrate their relative locations. The boundaries of the defined geographic area may be retained in the map image rendering for appreciation that the comparables are within the desired neighborhood. Additionally, grid data concerning comparable property details may be concurrently displayed alongside the map image.

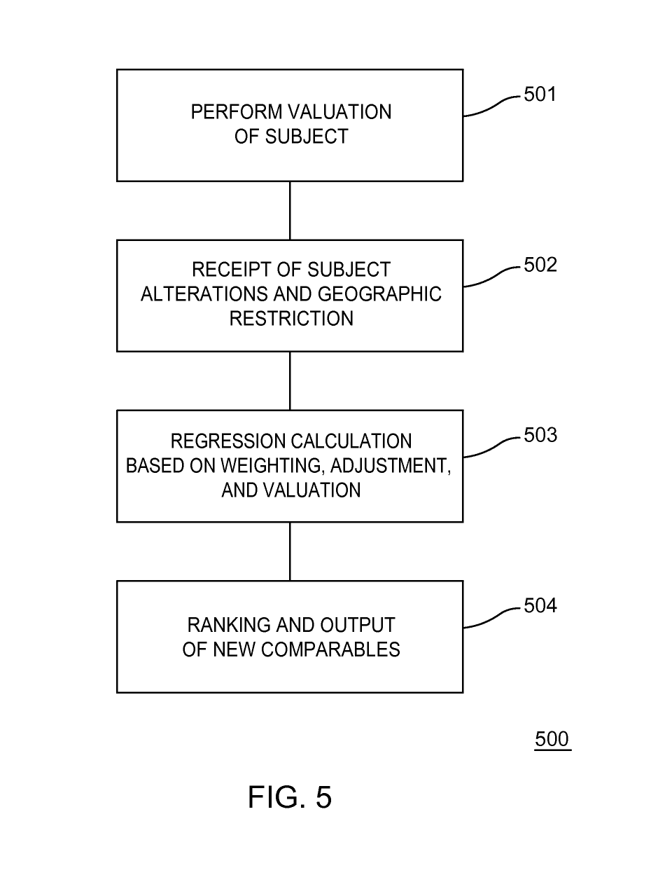

FIG. 5 is a flow diagram illustrating an example of a comparable selection process. Specifically, FIG. 5 is a flow diagram illustrating an example of a comparable selection process 500, where a comparable selection model is used to select the properties based on a chosen subject. Further, the comparable selection model selects the best comparable sales for a property using transaction level data and property characteristics. Furthermore, the described application uses a comparable selection model to value the subject or altered subject based on the best comparable sales for a property. For example, for each given alteration as described above, the model gauges through a regression calculation a new set of comparable properties along the dimensions of (i) comparable selection/comparable weighting, (ii) comparable adjustment, and (ii) final valuation from variables produced from the property data resources 112.

Specifically, a comparable selection process 500 will calculate 501 a valuation for a subject prior to its alteration. More specifically, when a subject property is identified, a comparable selection model through a regression based on coefficients related to property characteristics selects a set of comparable properties using the property data resources 112 (and the dimensions described above) to value the subject. This value is stored for later use by the application for ranking. Further, when the comparable selection model receives 502 input (for instance, from the input/output module 209), such as an altered subject, a customized geographic area, or both, the comparable selection model through a regression 503 based on the dimensions described above and the new conditions selects and ranks 504 a new set of comparable properties using the property data resources 112. The comparable selection model also values the altered subject, such that valuation and ranking may be carried out by the application.

Next, selecting set of comparable properties along the dimensions of (i) comparable selection/comparable weighting, (ii) comparable adjustment, and (ii) final valuation will be described. When evaluating comparable properties under the comparable selection category, the comparable selection model renders a score based on how well comparable sales compare to the altered subject in categories that drive the value of properties (i.e. explanatory variables). The explanatory variables may include rank ordering, distance from subject, age of comparable sale, and price distribution. Further, explanatory variables may include the property characteristics of gross living area, lot size, property age, number of bathrooms, number of bedrooms, geographical features of interest, maintenance conditions, waste removal systems, climate control systems, and parking availability.

When evaluating comparable properties based on weighting comparables the comparable selection model weighs comparables more heavily when the comparables more closely match an original or a new valuation of the subject. That is, based on A) a weighting of each comparable and on how closely each comparable matches the original valuation and B) a weighting of each comparable and on how closely each comparable matches the new valuation, a weighting is calculated for each comparable property and scores are assigned accordingly.

The next component of comparable selection involves the adjustment of comparable property values. That is, when evaluating comparables, the comparable selection model measures the adjustments made to the comparable properties. The comparable adjustments category captures two potential sources of appraisal error: (1) adjustments that are too large and boosting the adjusted price of sales comps beyond what is supported by the evidence and (2) adjustments that are too small and keep the adjusted price of sales comps higher than is supported by the evidence.

When evaluating an appraisal and its comparables under the final valuation category, the comparable selection model compares the final valuation of the subject to the selected comparable properties. Further, the comparable selection model compares the control comparable to the final valuation of the subject rendered by comparable selection model, such that the valuation bias or final valuation of comparable selection model that more closely match the valuation bias of the selected comparable properties may receive higher scores. In other words, the comparable selection model compares the subject to a set of selected comparable properties to generate a quality rating for the subject based on category scores. The regression modeling may vary, but in one example the property data is accessed and a regression models the relationship between price and explanatory variables.

Thus, embodiments of the described produce and provide methods and apparatus for a model for evaluating appraisals by comparing their comparable sales with selected comparable sales. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for valuation of a subject based on real-time property characteristic alterations using a comparable selection model, further comprising:
receiving an input that alters one or more property characteristics for a subject;
determining a ranked listing of comparable properties for the subject in a given geographical area by the comparable selection model based on the input; and
performing a valuation on the subject based on the ranked listing to render a value for the subject.

2. The method of claim 1, further comprising:
performing a valuation on the subject to render an original value prior to receiving the input.

3. The method of claim 2, further comprising:
calculating a difference between the value and the original value; and
ranking the value based on the difference between the value and the original value.

4. The method of claim 3, wherein ranking the value is based on cost estimates associated with the input.

5. The method of claim 3, wherein when more than one input is received and a new valuation is performed respective to each input, each new valuation is ranked based on its respective difference from the original valuation.

6. The method of claim 1, wherein the property characteristics include gross living area, lot size, property age, number of bathrooms, number of bedrooms, geographical feature of interest, maintenance conditions, waste removal systems, climate control systems, and parking.

7. The method of claim 1, further comprising:
displaying on a display device the value and the ranked listing of comparable properties,
wherein the display device is selected from a set of display devices that includes a light-emitting diode display, a liquid crystal display, an organic light-emitting diode display, a plasma display, and a cathode-ray display.

8. The method of claim 1, further comprising:
displaying on a display device the value and the ranked listing of comparable properties,
wherein the display device is connected to an electronic device,
wherein electronic device is selected from a set of electronic devices that includes personal computers, laptop personal computers, mobile phones, smart-phones, super-phones, tablet personal computers, and personal digital organizers.

9. A non-transitory computer readable medium storing program code for performing valuation of a subject based on real-time property characteristic alterations using a comparable selection model, the program code being executable to perform operations comprising:
receiving an input that alters one or more property characteristics for the subject;
determining a ranked listing of comparable properties for the subject in a given geographical area by the comparable selection model based on the input; and
performing a valuation on the subject based on the ranked listing to render a value for the subject.

10. A system for valuation of a subject based on real-time property characteristic alterations using a comparable selection model, the system comprising:
means for receiving an input that alters one or more property characteristics for the subject;
means for determining a ranked listing of comparable properties for the subject in a given geographical area by the comparable selection model based on the input; and
means for performing a valuation on the subject based on the ranked listing to render a value for the subject.

11. An apparatus that based on real-time property characteristic alterations using a comparable selection model performs a valuation, comprising:
a circuit that performs the valuation on a subject based on a ranked listing of comparable properties in a given geographical area to render a value for the subject after receiving an input that alters one or more property characteristics for the subject and determining the ranked listing of comparable properties for the subject in a given geographical area by the comparable selection model based on the input; and
a display that displays the value and the ranked listing of comparable properties.
